(19) United States
(12) Patent Application Publication
(10) Pub. No.: US 2026/0298454 A1
(43) Pub. Date: Oct. 1, 2026

(54) LIGHT FIXTURE HOIST

(71) Applicant: Daniel Flanagan, Tulsa, OK (US)

(72) Inventor: Daniel Flanagan, Tulsa, OK (US)

(21) Appl. No.: 19/096,871

(22) Filed: Apr. 1, 2025

(51) Int. Cl. F21V 21/38; F21S 8/06; F21V 21/008

(52) U.S. Cl. CPC F21V 21/38; F21S 8/061; F21V 21/008

(57) ABSTRACT

A hoist apparatus for lifting a lamp member of a hanging light fixture to mount it to a fixture mount of the hanging light fixture includes a housing which houses a spool, a hoist cable wound onto the spool, and a motor operatively coupled to the spool. A fixture mount connector is attached to a top side of the housing and is adapted to secure to the fixture mount. A fixture support connector is coupled to an end of the hoist cable and is configured to couple to a midsection of a flexible support member which is coupled to the lamp member. The hoist cable may be wound farther onto the spool to lift the flexible support member and the lamp member toward the fixture mount, where a free end of the flexible support member may be attached to the fixture mount.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to hoist apparatuses and more particularly pertains to a new hoist apparatus for lifting a lamp member of a hanging light fixture to mount it to a fixture mount of the hanging light fixture.

### (2) Description of Related Art Including Information Disclosed Under 37 CFR 1.97 and 1.98

The prior art describes myriad hoist apparatuses, including those in combination with a light fixture such that the light fixture may be hung from a ceiling and alternately lowered and raised to facilitate changing light bulbs or other maintenance activities. However, the prior art fails to describe such an apparatus which is adapted to secure to a fixture mount and a flexible support member attached to a lamp member such that the lamp member may be lifted and precisely positioned to secure the flexible support member to the fixture mount.

### (h) BRIEF SUMMARY OF THE INVENTION

An embodiment of the disclosure meets the needs presented above by generally comprising a housing and a fixture mount connector coupled to a top side of the housing. The fixture mount connector is configured to couple to a fixture mount of a hanging light fixture. A spool is rotatably mounted in the housing, and a hoist cable is wound onto the spool. The hoist cable extends away from the spool through a bottom side of the housing to a distal end of the hoist cable with respect to the spool. A fixture support connector is coupled to the distal end of the hoist cable and is configured to couple to a midsection of a flexible support member of the hanging light fixture. A motor is mounted in the housing and is operatively coupled to the spool, the motor is operable to rotate the spool alternately in a first rotational direction and a second rotational direction opposite the first rotational direction.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a hoist apparatus according to an embodiment of the disclosure.

FIG. 2 is a top perspective view of an embodiment of the disclosure.

FIG. 3 is a bottom perspective view of an embodiment of the disclosure.

FIG. 4 is a detail view of a housing of an embodiment of the disclosure.

FIG. 5 is a side view of an embodiment of the disclosure being used to lower a flexible support member and a lamp member downwardly from a fixture mount.

FIG. 6 is a side view of an embodiment of the disclosure being used to draw the flexible support member upwardly toward the fixture mount.

FIG. 7 is a side view of an embodiment of the disclosure being used to hold the flexible support member near the fixture mount while an end of the flexible support member is being attached to the fixture mount.

FIG. 8 is a side view of the lamp member hanging from the fixture mount via the flexible support member, the embodiment of the disclosure having been removed from the fixture mount and the flexible support member

### (j) DETAILED DESCRIPTION OF THE INVENTION

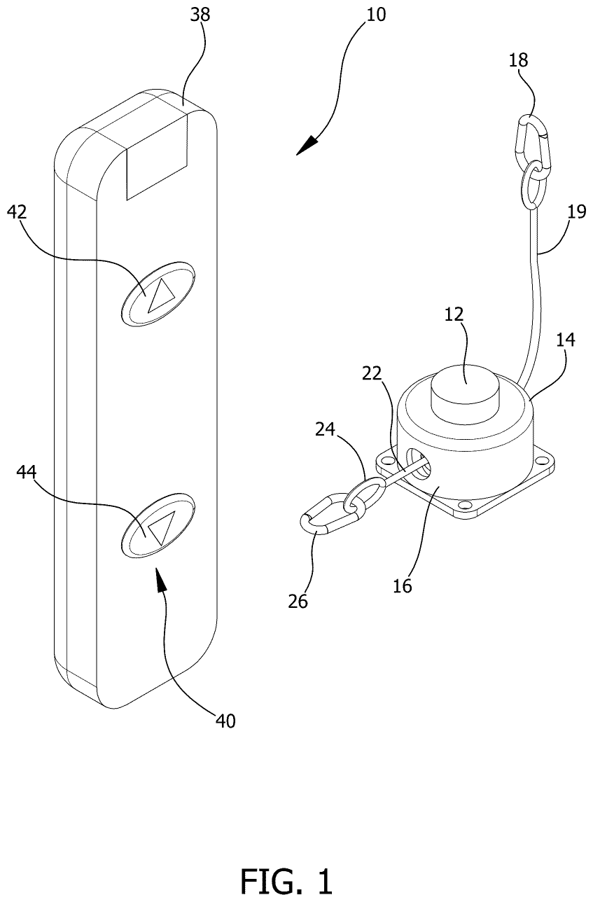

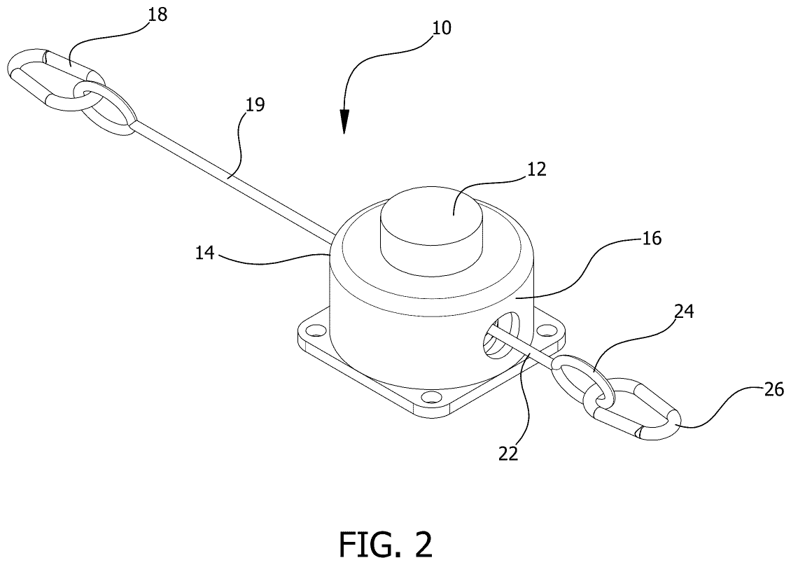

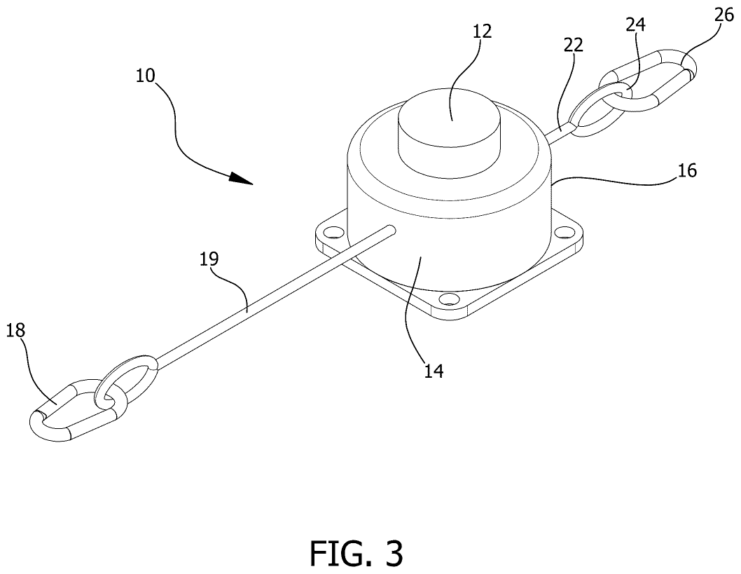

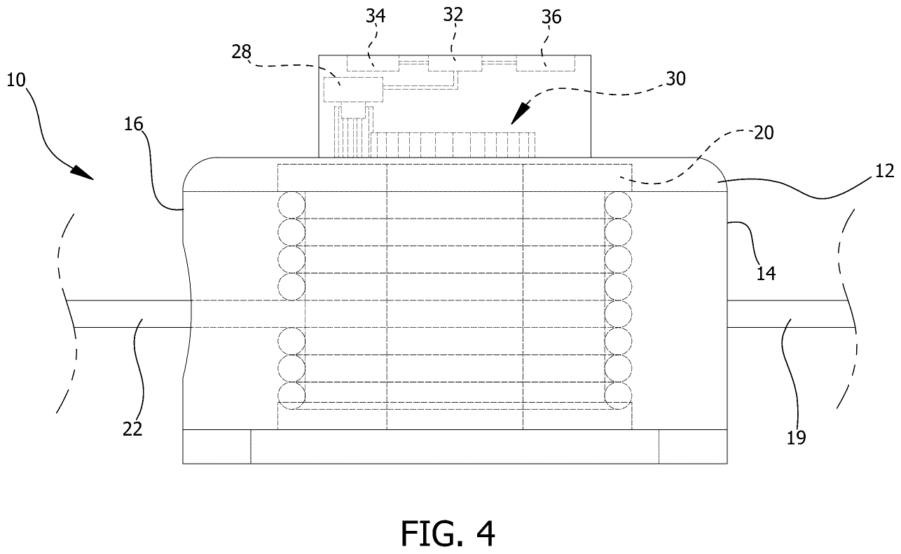

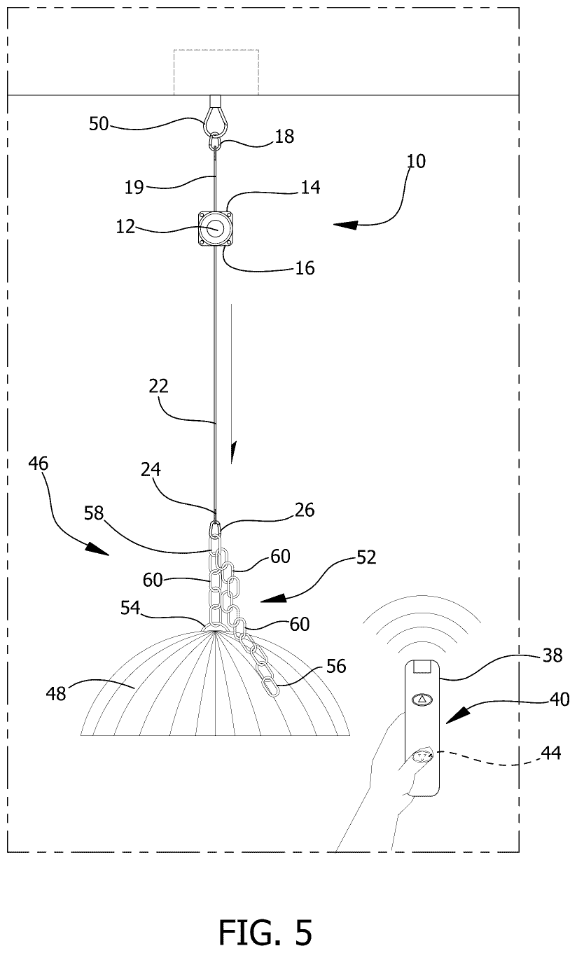

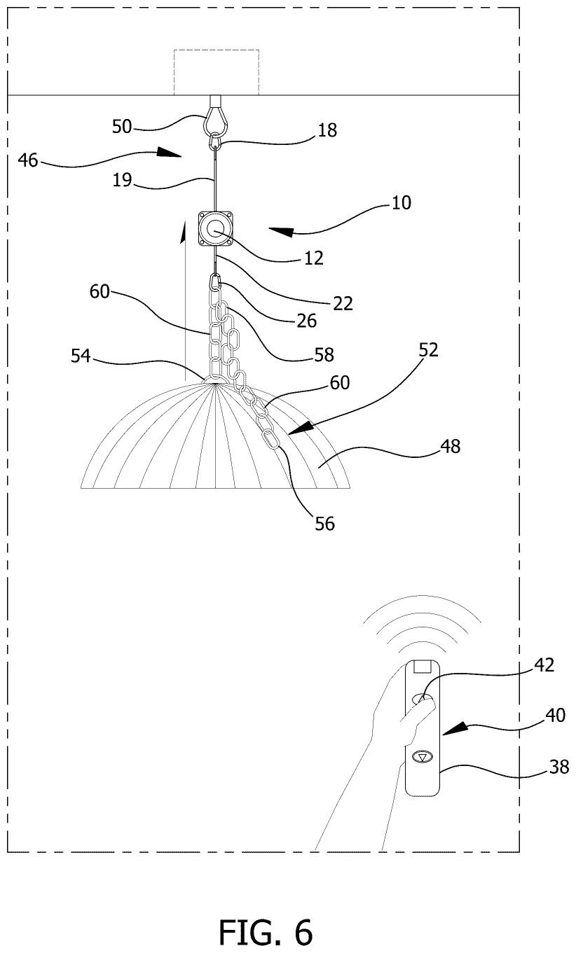

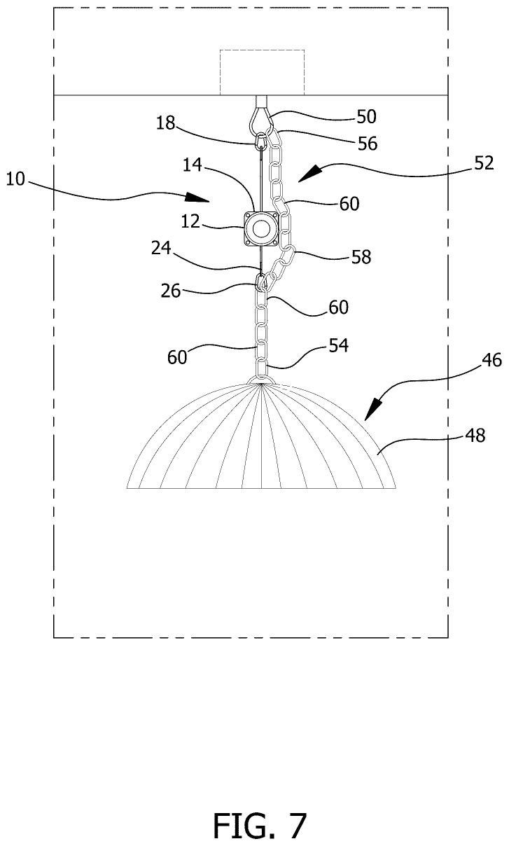

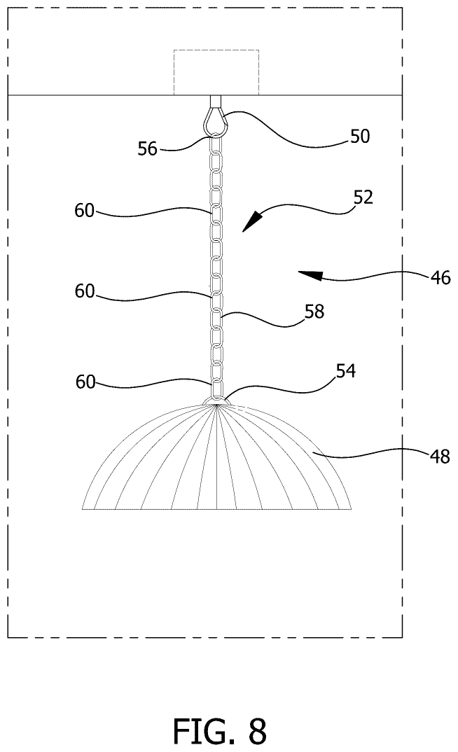

With reference now to the drawings, and in particular to FIGS. 1 through 8 thereof, a new hoist apparatus embodying the principles and concepts of an embodiment of the disclosure and generally designated by the reference numeral 10 will be described.

As best illustrated in FIGS. 1 through 8, the hoist apparatus 10 generally comprises a housing 12. A fixture mount connector 18 is coupled to a top side 14 of the housing 12 via a tether 19. The fixture mount connector 18 comprises a fixture mount interlocking fastener which links to a fixture mount 50 of a hanging light fixture 46. The fixture mount interlocking fastener is depicted as a carabiner in the Figures but may be a quick-link connector, a hook, or the like. The fixture mount connector 18 may comprise another suitable fastener such as a clamp, a threaded coupling, a snap fit connector, or the like.

A spool 20 is rotatably mounted in the housing 12, and a hoist cable 22 is wound onto the spool 20. The hoist cable 22 extends away from the spool 20 through a bottom side 16 of the housing 12 to a distal end 24 of the hoist cable 22 with respect to the spool 20. A fixture support connector 26 is coupled to the distal end 24 of the hoist cable 22 and is configured to attach to a midsection 58 of a flexible support member 52 of the hanging light fixture 46. As depicted in the Figures, the flexible support member 52 may be a chain, and the fixture support connector 26 comprises a fixture support interlocking fastener that may be used to link to one of a plurality of chain links 60 of the chain. The fixture support interlocking fastener is depicted as another carabiner in the Figures but also may be a quick-link connector, a hook, or the like. The fixture support interlocking fastener also may comprise another suitable fastener such as a clamp, a threaded coupling, a snap fit connector, or the like. Such fasteners may be used when the flexible support member 52 of the hanging light fixture 46 comprises a rope, a cord, or the like.

A motor 28 is mounted in the housing 12 and is operatively coupled to the spool 20. The motor 28 is operable to rotate the spool 20 alternately in a first rotational direction and a second rotational direction opposite the first rotational direction. The motor 28 may, for example, wind the hoist cable 22 onto the spool 20 by rotating the spool 20 in the first rotational direction and may unwind the hoist cable 22 from the spool 20 by rotating the spool 20 in the second rotational direction. A geartrain 30 operatively couples the motor 28 to the spool 20, and gears of the geartrain 30 may be sized and arranged to result in a gear reduction that reduces a speed and increases a torque of the spool 20 relative to an output shaft of the motor 28. Other powertrain elements also may be used, such as rope-and-pully mechanisms or the like.

A processor 32 is mounted in the housing 12 and is operatively coupled to the motor 28. A receiver 34 is mounted in the housing 12 and is operatively coupled to the processor 32. A power supply 36 is mounted in the housing 12 and is electrically coupled to the processor 32. The power supply 36 comprises a battery but may comprise a capacitor or other suitable energy storage. In some embodiments, the processor 32 may be powered by connecting to a utility power source or other external power source. The power supply 36 powers the motor 28 and the receiver 34 via the processor 32 but may be directly coupled to the same in other embodiments.

A remote controller 38 is operatively coupled to the processor 32 via the receiver 34. The remote controller 38 comprises an input 40 for receiving commands to control the processor 32 and a transmitter sufficient for communicating the commands to the processor 32 via the receiver 34. In some embodiments, the receiver 34 and the transmitter may be transceivers such that the processor 32 may transmit signals to the transmitter via the transceivers. The input 40 comprises an up button 42 for directing the processor 32 to cause the motor 28 to wind the hoist cable 22 onto the spool 20 and a down button 44 for directing the processor 32 to cause the motor 28 to unwind the hoist cable 22 from the spool 20. In other embodiments, the input 40 may comprise a touchscreen, a knob, a toggle switch, or other suitable interface. The remote controller 38 may also include another battery or other suitable power source.

In use, the fixture mount connector 18 is attached to the fixture mount 50 when the fixture mount 50 is mounted in a ceiling or other suitable support structure, and the fixture support connector 26 is attached to the midsection 58 of the flexible support member 52. The motor 28 is operated via entering commands on the input 40 of the remote controller 38 to wind the hoist cable 22 onto the spool 20, thereby raising the flexible support member 52 and a lamp member 48 of the hanging light fixture 46 that is mounted to a first end 54 of the flexible support member 52 toward the fixture mount 50.

When the flexible support member 52 is drawn near enough to the flexible mount via winding the hoist cable 22 onto the spool 20, the motor 28 is stopped via the input 40 of the remote controller 38. A second end 56 of the flexible support member 52 opposite the first end 54 may then be attached to the fixture mount 50. Ideally, the flexible support member 52 is positioned relative to the fixture mount 50 such that the second end 56 of the flexible support member 52 just reaches the fixture mount 50. With such positioning, the fixture mount connector 18 may be removed from the fixture mount 50 and the fixture support connector 26 may be removed from the flexible support member 52 such that a weight of the lamp member 48 of the hanging light fixture 46 is transferred from the hoist apparatus 10 to only the flexible support member 52 and the fixture mount 50 without requiring additional movement of the lamp member 48. The midsection 58 of the flexible support member 52 also may be lowered after the second end 56 of the flexible support member 52 is attached to the fixture mount 50 to transfer the weight of the lamp member 48 without causing the weight to be born be an individual or other material handling device.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hoist apparatus for a hanging light fixture, the hoist apparatus comprising:
a housing;
a fixture mount connector coupled to a top side of the housing, the fixture mount connector being configured to couple to a fixture mount of the hanging light fixture;
a spool rotatably mounted in the housing;
a hoist cable wound onto the spool, the hoist cable extending away from the spool through a bottom side of the housing to a distal end of the hoist cable with respect to the spool;
a fixture support connector coupled to the distal end of the hoist cable and configured to couple to a midsection of a flexible support member of the hanging light fixture;
a motor mounted in the housing and operatively coupled to the spool, the motor being operable to rotate the spool alternately in a first rotational direction and a second rotational direction opposite the first rotational direction;
wherein the fixture mount connector comprising a fixture mount interlocking fastener being a first carabiner configured to link to the fixture mount; and
wherein the fixture support connector comprises a fixture support interlocking fastener being a second carabiner configured to link to one of a plurality of chain links of the flexible support member of the hanging light fixture.

2. (canceled)

3. The hoist apparatus of claim 1, further comprising a tether coupled to and extending between the housing and the fixture mount interlocking fastener, the fixture mount interlocking fastener being coupled to the housing via the tether.

4. (canceled)

5. The hoist apparatus of claim 1, further comprising a geartrain operatively coupling the motor to the spool.

6. The hoist apparatus of claim 1, further comprising:
a processor mounted in the housing and operatively coupled to the motor;
a receiver mounted in the housing and operatively coupled to the processor; and
a remote controller operatively coupled to the processor, the remote controller being configured to control the processor wirelessly via the receiver, the remote controller comprising an input for receiving commands for controlling the processor.

7. The hoist apparatus of claim 6, further comprising a power supply mounted in the housing and electrically coupled to the processor, the power supply comprising a battery.

8. A hoist apparatus for a hanging light fixture, the hoist apparatus comprising:
a housing;
a fixture mount connector coupled to a top side of the housing, the fixture mount connector comprising a fixture mount interlocking fastener being a first carabiner configured to link to a fixture mount of the hanging light fixture;
a tether coupled to and extending between the housing and the fixture mount interlocking fastener, the fixture mount interlocking fastener being coupled to the housing via the tether;
a spool rotatably mounted in the housing;
a hoist cable wound onto the spool, the hoist cable extending away from the spool through a bottom side of the housing to a distal end of the hoist cable with respect to the spool;
a fixture support connector coupled to the distal end of the hoist cable, the fixture support connector comprising a fixture support interlocking fastener being a second carabiner configured to link to one of a plurality of chain links of a flexible support member of the hanging light fixture;
a motor mounted in the housing and operatively coupled to the spool, the motor being operable to rotate the spool alternately in a first rotational direction and a second rotational direction opposite the first rotational direction;
a geartrain operatively coupling the motor to the spool;
a processor mounted in the housing and operatively coupled to the motor;
a receiver mounted in the housing and operatively coupled to the processor;
a power supply mounted in the housing and electrically coupled to the processor, the power supply comprising a battery; and
a remote controller operatively coupled to the processor, the remote controller being configured to control the processor wirelessly via the receiver, the remote controller comprising an input for receiving commands for controlling the processor.
